(19) United States
(12) Patent Application Publication
(10) Pub. No.: US 2009/0171721 A1
(43) Pub. Date: Jul. 2, 2009

(54) Bidding system for search engine marketing

(76) Inventors: Matt LeBaron, Marina, CA (US); Haengiu Lee, Rochester, NY (US)

Correspondence Address: Soquel Group, LLC, P.O. Box 691, Soquel, CA, 95073, US

(21) Appl. No.: 12/006,009

(22) Filed: Dec. 28, 2007

(51) Int. Cl. G06Q 30/00; G06F 17/30

(52) U.S. Cl. 705/7

(57) ABSTRACT

A method for search engine keyword bidding, including providing a search engine that is used by shoppers to search for products and services, maintaining by an advertiser a keyword database used by the search engine, collecting by the advertiser statistics for revenue generated during each Internet session on the advertiser's website that begins when a shopper visits the advertiser's landing page in response to the shopper clicking on an advertiser's sponsored ad, maintaining by the advertiser a tracking database comprising records of Internet sessions for a plurality of shoppers, and periodically revising by the advertiser a bid amount for a keyword in the keyword database, based on total revenue in the tracking database corresponding to the keyword over a given time period.

### FIELD OF THE INVENTION

The present invention relates to online advertising and search engine marketing.

### BACKGROUND OF THE INVENTION

Online advertising enables individuals and organizations to advertise their products and services on websites. One form of online advertising is search engine marketing (SEM) that promotes websites by increasing their visibility in results pages provided by search engines using paid search advertisements. In search engine marketing, keyword searches result in web pages that include unpaid search listings as well as paid search listings. Such web pages are commonly referred to as “search results pages”. Paid search listings are commonly referred to as “sponsored ads”, or simply “ads” or “advertisements”. Currently, the largest SEM operators are Google AdWords, Yahoo! Search Marketing and Microsoft adCenter. By way of distinction, the term search engine optimization (SEO) refers to methods that seek to obtain better positions among unpaid search listings.

Advertisers place online advertisements with SEM operators and the ads appear in response to keyword searches performed by visitors. An advertiser is a company that places ads for its own products and services or an agency that places ads on behalf of a client company that sells products and services. When a visitor, also referred to as a “user”, or a “shopper”, clicks on an online advertisement that appears in a search results page, he/she is linked to a web page that has been supplied by an advertiser. This type of web page is commonly referred to as a “landing page” and it typically displays content and/or advertisements that are relevant to the user's search.

A variety of payment schemes are used in search engine marketing. The most common is pay per click (PPC) in which the advertiser places bids on keywords. When a visitor enters one of these keywords into a search box, the advertiser's ad appears in a search results page. If the visitor clicks on the ad, then the advertiser pays the bid amount to the operator of the SEM system. The bid refers to the price that the advertiser is willing to pay the SEM system operator, also referred to as “SEM operator”, when a visitor clicks on a sponsored ad and consequently visits the advertiser's landing page.

The amount of the bid submitted by an advertiser for a keyword determines the priority of their sponsored ad. Generally, the greater the bid amount the more desirable is the location of the sponsored ad on the search results page.

In addition, some SEM operators take into account visitors' responses to the sponsored ad. For example, if two advertisers bid the same amount for the same keyword, the SEM operator may afford the advertiser whose ad has historically generated a higher click through rate a higher ranking among the sponsored search results for the keyword. For purposes of clarity, click through rate refers to the percentage of visitors to a web page that click on a sponsored ad that appears in the web page. In some cases, advertisers with better performing ads may pay less to achieve a particular ranking among the sponsored search results for a keyword than advertisers with higher bids but with poorer performing ads.

Advertisers confront several issues when determining bid amounts for keywords. Importantly, an advertiser does not know in advance the traffic volume that will be generated when they bid on a keyword and place an ad. Thus, the bid amount is generally modified over a period of time in order to achieve the desired volume of traffic or return on investment (ROI) for their investment in sponsored ads.

Additionally, ad results can be impacted by external factors including the entry of new advertisers that bid on the same keywords or the departure of advertisers that previously bid on the same keywords. Another external factor that may affect ad results is changing tastes and interests on the part of shoppers. For example, if an advertiser bid on the term “rap music” but over a period of time the term “hip hop music” became a more popular expression for the same music, then the advertiser might want to lower their bid for the term “rap music” and place an additional bid on the term “hip hop music.” Thus, there is a need for methods to determine bid amounts to (1) initially achieve a desired level of traffic, (2) achieve a desired return on investment, and (3) react to external factors that cause fluctuations in traffic.

It is not uncommon for businesses that employ online advertising to purchase hundreds or thousands of keywords from one or more search engines. For example, advertisers that manage large e-commerce websites that sell many products may need to bid on tens of thousands of keywords. Typically, such large numbers of keywords are managed manually by human users using a spreadsheet (e.g., Excel by Microsoft Corporation) or word processor (e.g., Word by Microsoft Corporation). Users generally list the keywords in a spreadsheet or word processor, update the bid information periodically, and then convert the document such that the keywords are listed in a format that is convertible and uploadable to a search engine. Therefore, those skilled in the art will note that such manual management of keywords can be time consuming and prone to error. Thus, there is a need for automated, efficient methods for determining and managing bids.

Additionally, an advertiser's goals may change. For example, an advertiser may desire to generate additional traffic during the end-of-year holiday season because historic trends show that website visitors are more likely to consummate purchases during this calendar period. However, increasing the bid amount means that the advertiser pays more to the search engine marketing system operator for each click on a sponsored ad and therefore the advertiser may want to limit the bid based on profitability objectives. Thus, there is a need for methods that enable an advertiser to modify bids so as to meet goals for traffic volume and profitability.

### SUMMARY OF THE DESCRIPTION

The present invention concerns online advertising, and more specifically the practice of promoting websites through the use of paid advertisements displayed by search engines, commonly referred to as search engine marketing (SEM). Aspects of the present invention provide systems and methods that enable online advertisers to periodically update bids for Internet search keywords, in response to which paid advertisements are displayed in search results pages.

The present invention enables an online advertiser that operates an e-commerce website to automatically submit keywords and keyword bid amounts to search engine marketing operators (SEM operators) and to periodically update the keywords and keyword bids in accordance with financial objectives and constraints. The present invention stores historical data concerning sales and advertising generated on the advertiser's e-commerce website, and uses this data to calcuate updated bids. The present invention allows the advertiser to establish profitability objectives and to set lower and upper bid limits.

There is thus provided in accordance with an embodiment of the present invention a method for search engine keyword bidding, including providing a search engine that is used by shoppers to search for products and services, wherein the search engine receives at least one designated keyword as input and generates a ranked list of at least one ad related to the at least one designated keyword as output, wherein each ad is sponsored by an advertiser and has a bid amount associated therewith and includes a link to a landing page of an advertiser's website, and wherein higher ranked ads are more prominently displayed by the search engine and generally generate more revenue than lower ranked ads, maintaining by an advertiser a keyword database used by the search engine, the keyword database comprising records, each record including a designated keyword, an ad sponsored by the advertiser that is displayed by the search engine in response to a search using the designated keyword, and a bid amount that is paid by the advertiser to an operator of the search engine as a fee each time a shopper clicks on the advertiser's sponsored ad that is displayed by the search engine in response to the shopper's search using the designated keyword, collecting by the advertiser statistics for revenue generated during each Internet session on the advertiser's website that begins when a shopper visits the advertiser's landing page in response to the shopper clicking on an advertiser's sponsored ad, maintaining by the advertiser a tracking database comprising records of Internet sessions for a plurality of shoppers, each record including a designated keyword corresponding to the sponsored ad that the shopper clicked on, a time and date of the shopper's Internet session, and revenue generated for the advertiser during the shopper's Internet session, and periodically revising by the advertiser a bid amount for a keyword in the keyword database, based on total revenue in the tracking database corresponding to the keyword over a given time period.

There is additionally provided in accordance with an embodiment of the present invention a system for keyword bidding within a search engine marketing system, including an interface for a search engine that is used by shoppers to search for products and services, wherein the search engine receives at least one designated keyword as input and generates a ranked list of at least one ad related to the at least one designated keyword as output, wherein each ad is sponsored by an advertiser and has a bid amount associated therewith and includes a link to a landing page of an advertiser's website, wherein the list of sponsored ads generated by the search engine is ranked in order of the ads' respective bid amounts, and wherein higher ranked ads are more prominently displayed by the search engine and generally generate more revenue than lower ranked ads, a memory for storing a keyword database used by the search engine, the keyword database comprising records, each record including a designated keyword, an ad sponsored by the advertiser that is displayed by the search engine in response to a search using the designated keyword, and a bid amount that is paid by the advertiser to an operator of the search engine as a fee each time a shopper clicks on the advertiser's sponsored ad that is displayed by the search engine in response to the shopper's search using the designated keyword, and a tracking database comprising records of Internet sessions for a plurality of shoppers, each record including a designated keyword corresponding to a sponsored ad that a shopper clicked on, a time and date of the shopper's Internet session, and, revenue generated for the advertiser during the shopper's Internet session, a keyword tracker communicatively coupled with the tracking database, for collecting statistics for revenue generated during each Internet session on the advertiser's website that begins when a shopper visits the advertiser's landing page in response to the shopper clicking on an advertiser's sponsored ad, and a bid calculator communicatively coupled with the keyword database and the tracking database, for periodically revising by the advertiser a bid amount for a keyword in the keyword database, based on total revenue in the tracking database corresponding to the keyword over a given time period.

### BRIEF DESCRIPTION OF THE DRAWINGS

The subject invention will be more fully understood and appreciated from the following detailed description, taken in conjunction with the drawings in which:

FIG. 1 is a simplified block diagram of a search engine marketing system, in accordance with an embodiment of the subject invention;

FIG. 2 is a simplified block diagram of a search engine marketing system with affiliates, in accordance with an embodiment of the subject invention;

FIG. 3 is an exemplary advertiser landing page, in accordance with an embodiment of the subject invention;

FIG. 4 is a simplified block diagram of a search engine marketing system, in accordance with an embodiment of the subject invention;

FIG. 5 is a simplified flowchart of an overall method for updating keyword bids, in accordance with an embodiment of the present invention;

FIG. 6 is an exemplary web user interface that shows the keyword information provided by a search engine marketing operator, in accordance with an embodiment of the subject invention;

FIG. 7 is an exemplary web user interface used by a keyword reviewer to select keywords, in accordance with an embodiment of the subject invention;

FIG. 8 is an exemplary web user interface used by a keyword reviewer to review keywords and approve or disapprove them, in accordance with an embodiment of the subject invention;

FIG. 9 is a flowchart describing the processing steps performed by a keyword bidding algorithm to determine the amount to bid for a keyword, in accordance with an embodiment of the subject invention.

FIG. 10 is a flowchart describing the processing steps performed by a keyword prospecting algorithm to determine the amount to bid for a keyword, in accordance with an embodiment of the subject invention.

FIG. 11 is a flowchart describing the processing steps performed by a keyword profitability algorithm to determine an optimal bid for a keyword, in accordance with an embodiment of the subject invention.

### DETAILED DESCRIPTION

The present invention concerns a search engine marketing (SEM) system, or simply “SEM system,” that determines the proper bids for keywords.

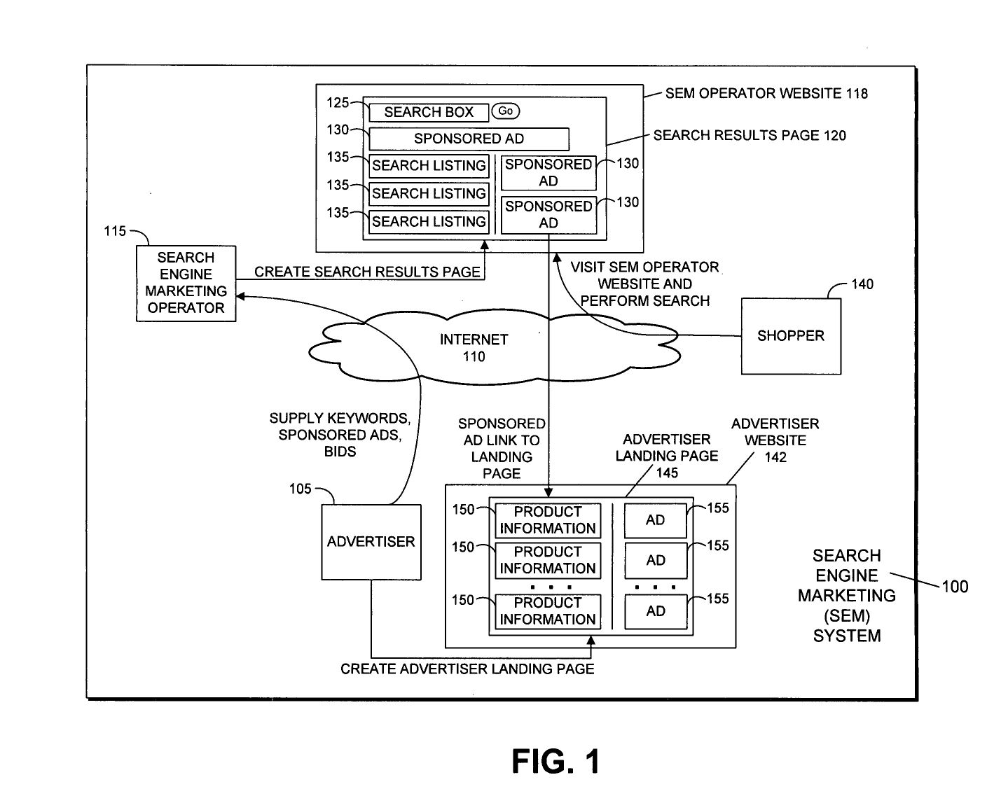

Reference is now made to FIG. 1, a simplified block diagram of a search engine marketing system 100, in accordance with an embodiment of the subject invention. A search engine marketing (SEM) system 100 enables an advertiser 105 to place paid ads, commonly referred to as “sponsored ads” or “sponsored links,” into search results pages. Advertiser 105 is a person or organization that places electronic advertisements that appear in search results pages. To place advertisements, advertiser 105 supplies keywords, a sponsored advertisement for each keyword, and a bid for each keyword to a search engine marketing operator (SEM operator) 115. SEM operator 115 operates a SEM operator website that enables a shopper to perform keyword searches. SEM operator website 118 enables a shopper to enter keywords into a search box and in response displays a search results page.

For purposes of clarity, shopper 140 refers to a person that uses a standard web browser such as Microsoft Internet Explorer or Mozilla Firefox to visit SEM operator website 118 and perform a keyword search. The interaction between the shopper 140 web browser and the SEM operator website 118 is performed across the Internet 110 and uses standard web protocols such as Hypertext Markup Language (HTML) and Hypertext Transport Protocol (HTTP).

When shopper 140 performs a keyword search, SEM operator website 118, displays a search results page. If shopper 140 enters a keyword supplied by advertiser 105 to SEM operator 115 into then search results page 120 may include a sponsored ad corresponding to the keyword. For example, if advertiser 105 has bid upon the keywords “monterey bay whale watching” and shopper 140 enters “monterey bay whale watching” in a search box 125, then the sponsored ad placed by advertiser 105 will be displayed, along with ads placed by other advertisers. It is noted that in the event that a plurality of advertisers bid on the same keywords there may not be sufficient space on the web page to display all bidders' ads and consequently some ads may not always appear.

Search results page 120 created by SEM operator 115 generally includes sponsored ads 130 above or beside search listings 135, where search listings 135 refer to the unpaid search results. From search results page 120, shoppers 140 may click on search listings 135, click on sponsored ads 130 or may perform additional searches by entering keywords into search box 125.

Advertiser 105 pays a bid amount to search engine marketing operator 115 for each click made by a shopper 140 on a sponsored ad supplied by advertiser 105. For purposes of clarification, the bid amount assessed by SEM operator 115 is typically either equal to the bid amount provided by advertiser 105 or is one cent more than the next lowest bid, whichever is lower. This pricing model is generally referred to as pay per click (PPC).

When shopper 140 clicks on a sponsored ad 130 that appears in search results page 120, the shopper's web browser is directed to an advertiser landing page 145.

A bid represents the amount of money that advertiser 105 is willing to pay to search engine marketing (SEM) operator 115 each time a shopper 140 clicks on advertiser's sponsored ad. The bid submitted by advertiser 105 for a keyword determines the priority of the corresponding ad. For example, if a first advertiser 105 bids $0.25 per click for the keyword “high performance motorcycle” and a second advertiser 105 bids $0.50 per click then the advertisement submitted by the second advertiser 105 will generally be placed in a more desirable location in search results page 120 that is generated when shopper 140 searches on the keyword “high performance motorcycle.” However, some SEM operators use quality-based bidding where the performance of a specific ad, in addition to the bid amount, is taken into account when determining the location on the web page where the ad is displayed. Typically, ad performance is measured by the click through rate, which is defined as the percentage of ad viewers that click on the ad. When quality-based bidding is used, advertisers with well performing ads may pay less for top placement.

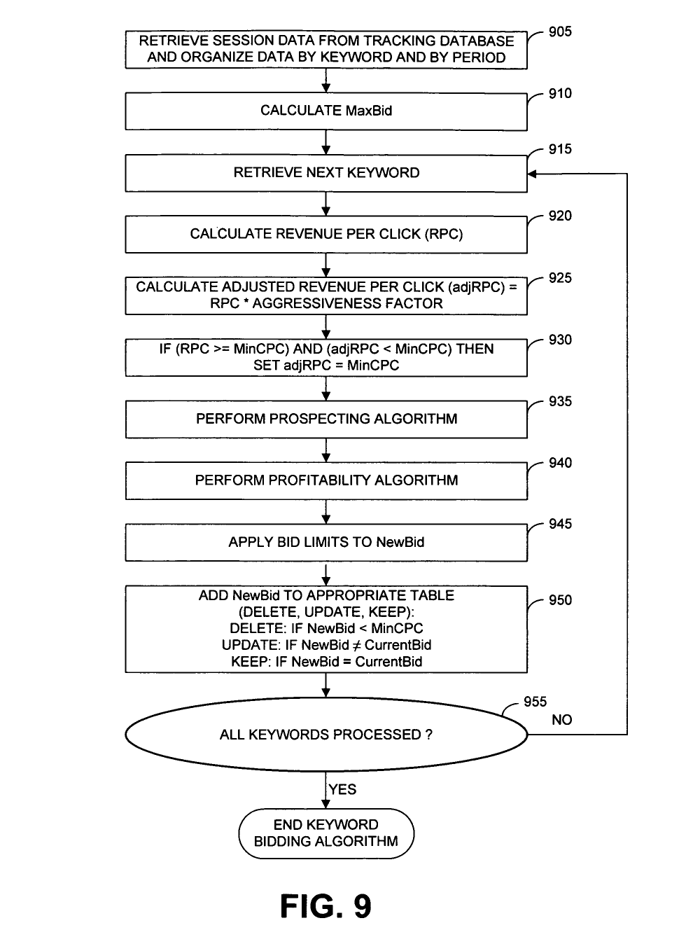

The subject invention includes a bidding algorithm, described with reference to FIG. 9, which automatically determines a bid amount for each keyword submitted by advertiser 105 to SEM operator 115.

Typically, an electronic advertisement supplied by advertiser 105 is in the form of text or an HTML code snippet that can be easily incorporated into a search results page 120. If the ad is in the form of text then a link to an advertiser landing page 145 is additionally supplied by the advertiser. If the ad is HTML formatted, then the HTML code snippet contains a link to an advertiser landing page 145. Under the pay per click (PPC) pricing model, advertiser 105 is assessed a bid amount by SEM operator 115 each time shopper 140 clicks on a sponsored ad in a search results page 120. It is noted that advertiser 105 is only assessed a bid amount when a visitor actually clicks on an ad and consequently visits advertiser landing page 145.

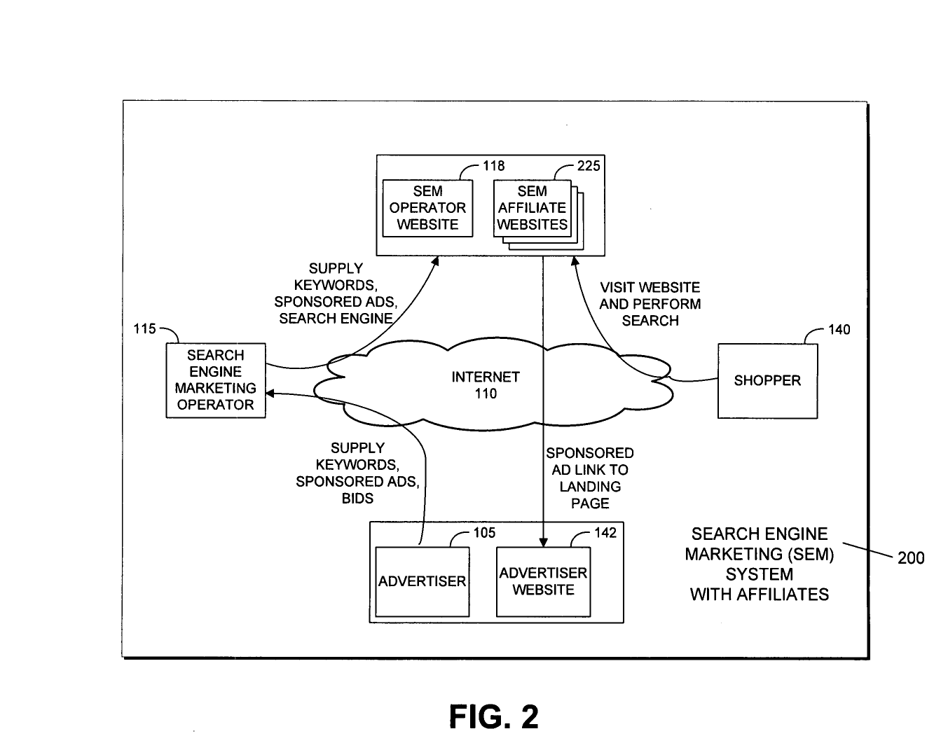

In one embodiment, advertiser landing page 145 includes product information 150 about one or more products and, optionally, one or more ads 155. Ads 155 can be sold directly by advertiser 105 to other advertisers using a variety of advertising payment models. Alternatively, as will be discussed with respect to FIG. 2, advertiser 105 can become a SEM system affiliate, in which case ad 155 is provided by SEM operator 115. Advertiser landing page 145 is described in further detail with respect to FIG. 2. Advertiser landing page 145 is one of many web pages that may appear on advertiser website 142. Advertiser website 142 is a site (location) on the World Wide Web (“web”) that contains a plurality of web pages. Typical functions provided by advertiser website 142 include e-commerce, display of product information, and online advertising. Advertiser website 142 is controlled by advertiser 105.

In the e-commerce model employed by SEM system 100, advertiser 105 submits keyword bids to SEM operator 115 in order to attract shoppers 140 to advertiser website 142 from which it sells products or generates advertising revenue. Advertiser website 142 earns revenue either by selling or causing the sale of the products referred to by product information 150, or through placement of ads 155. Advertiser website 142 may sell products directly to shoppers 140 and collect product sales revenue from them or advertiser website 142 may refer shoppers 140 to sellers and collect a sales commission from them. Advertiser 105 earns advertising revenue from other advertisers that place ads 155 on advertiser landing page 145 and on other web pages provided by advertiser website 142. Among the advertising models that advertiser 105 may use are cost per placement, also referred to as CPM, and pay per click (PPC). In the CPM model, advertiser website 142 receives from other advertisers an agreed upon amount for every thousand times shoppers 140 view the ad. In the PPC model, advertiser website 142 earns advertising revenue from other advertisers when shopper 140 clicks on an ad 155 displayed on advertiser landing page 145 or on an ad displayed on another web page provided by advertiser website 142.

Now reference is made to FIG. 2, a simplified block diagram of a search engine marketing (SEM) system with affiliates, in accordance with an embodiment of the subject invention. FIG. 2 includes several elements previously described with respect to FIG. 1. Specifically, search engine marketing operator 115, SEM operator website 118, Internet 110, advertiser 105, shopper 140, and advertiser website 142 are identical to the similarly named elements described with respect to FIG. 1. A SEM system with affiliates broadens the scope of the SEM system described with reference to FIG. 1 by enabling SEM affiliates, which are organizations independent from SEM operator 115 to operate SEM affiliate websites 225 that serve sponsored ads provided by SEM operator 115. SEM operator 115 shares advertising revenue generated by SEM affiliate websites 225 with the SEM affiliates. Similarly to SEM system 100, advertiser 105 supplies keywords, sponsored ads, and bids to SEM operator 115. SEM operator 115 in turn supplies keywords and sponsored ads to SEM operator website 118 as well as to SEM affiliate websites 225. As an example, both Google and Yahoo! operate their own website and also serve advertising to affiliate websites. Typically, SEM operator 115 also provides search engine technology to both SEM operator website 118 and SEM affiliate websites 225, as will be discussed below. Shopper 140 may visit SEM operator website 118 or SEM affiliate websites 225 and perform keyword searches. The search results pages that are created and displayed in response contain sponsored ads supplied by advertiser 105. When shopper 140 clicks on a sponsored ad supplied by advertiser 105 his/her web browser is directed to said advertiser website 142 which displays an advertiser landing page 145 (FIG. 1).

According to the pay per click pricing scheme, which is also employed in SEM system with affiliates 200, advertiser 105 is assessed a bid amount each time shopper 140 performs a keyword search on either SEM operator website 118 or SEM affiliate website 225 and then clicks on a sponsored ad in a search results page. However, if shopper 140 is visiting a SEM affiliate website 225, then SEM operator 115 shares the bid revenue that it collects with the SEM affiliate. For example, if SEM operator 115 and SEM affiliate agree to split revenue 30% for SEM operator 115 and 70% for SEM affiliate and the bid amount is fifty cents ($0.50), then SEM operator 115 keeps 15 cents and pays SEM affiliate a thirty five cent commission.

There are a number of methods by which SEM operator 115 can provide search engine technology, including: (1) SEM operator can host the search capability, i.e. perform the searches on its own servers and return search results pages to SEM operator website 118 and SEM affiliate website 225; (2) SEM operator can provide search servers in the form of software modules or computer systems that are incorporated into SEM operator website 118 and SEM affiliate website 225.

In one embodiment, advertiser website 142 displays advertiser landing pages 145 (FIG. 1) that include both product information 150 and ads 155. Advertiser 105 may become an affiliate to SEM operator, in which case advertiser website 240 operates as a SEM affiliate website 225. In this case, ads 155 are provided by SEM operator 115. In this case, if shopper 140 clicks on ad 155 then the advertiser that placed ad 155 pays the bid amount for the corresponding keyword to SEM operator 115. SEM operator 115 in turn provides a share of this advertising revenue to advertiser 105.

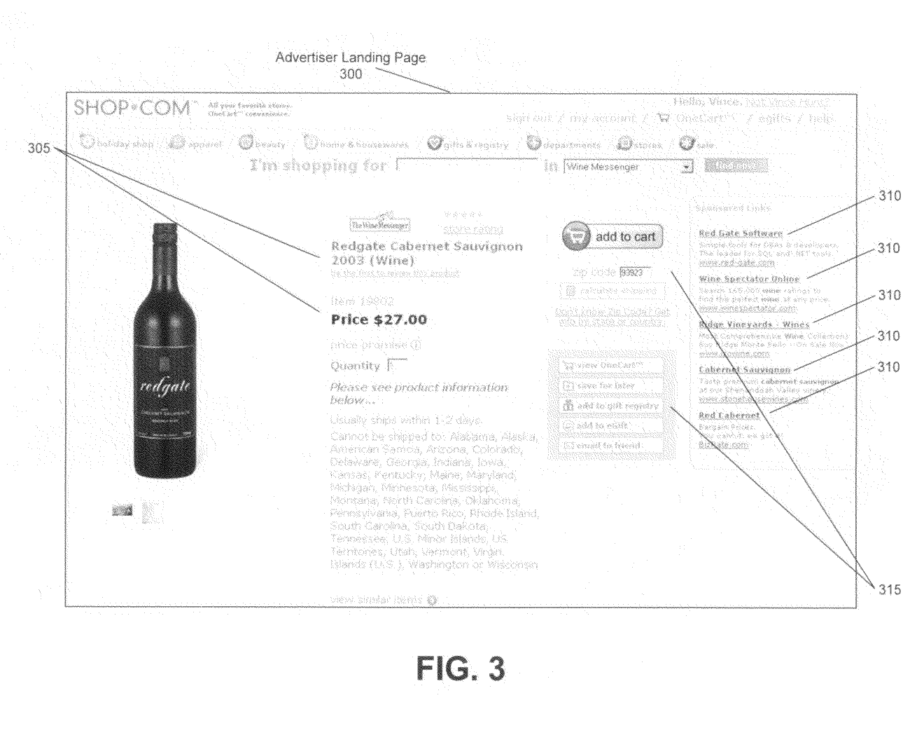

Reference is now made to FIG. 3, which is an exemplary advertiser landing page, in accordance with an embodiment of the subject invention. To reach advertiser landing page 300, shopper 140 first performs a keyword search on SEM operator website 118 or SEM affiliate website 225 and then clicks on a sponsored ad that appears in a search results page. The web browser being used by shopper 140 is then redirected to advertiser website 142 where advertiser landing page 300 appears. On the left side of advertiser landing page 300, detailed product information 305 is shown. Five sponsored ads 310 appear on the right side of advertiser landing page 300. In the center of the web page, several e-commerce functions 315 available to shopper 140 are displayed. E-commerce functions include adding the item to a shopping cart, entering a zip code and calculating shipping cost, viewing the cart, saving the item for later, adding the item to a gift registry, adding to an electronic gift order, and emailing information about the item to one or more persons.

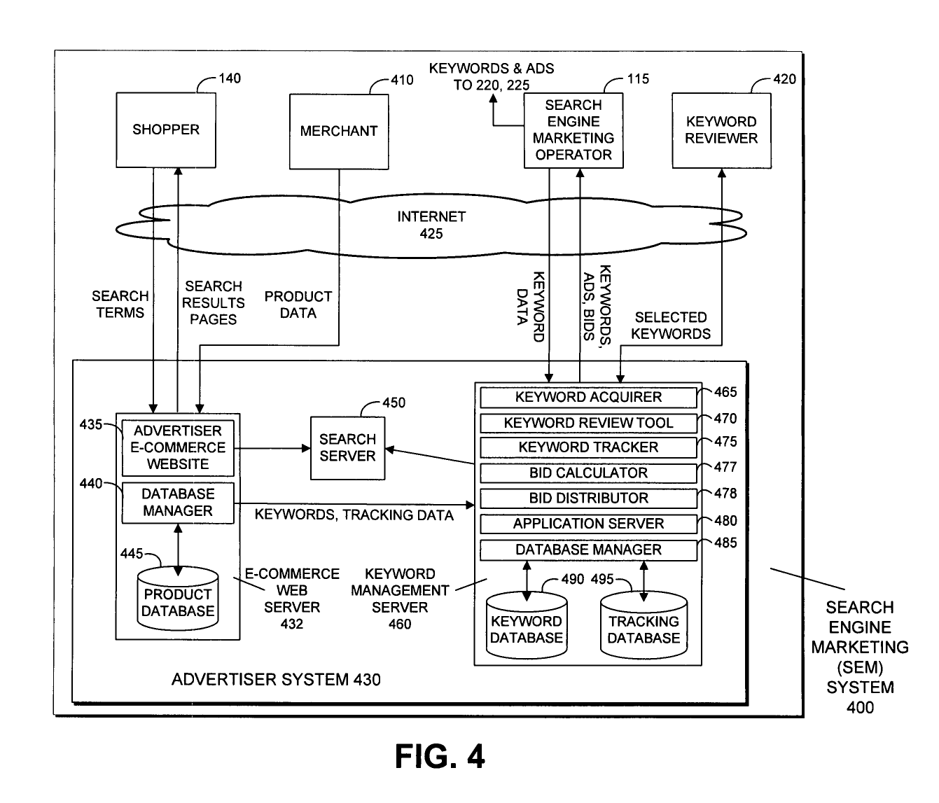

Reference is now made to FIG. 4, a simplified block diagram of a search engine marketing system, in accordance with an embodiment of the subject invention. FIG. 4 describes an embodiment of an advertiser system 430 that follows the model described with respect to FIG. 1 and FIG. 2. To the model described with respect to FIG. 1 and FIG. 2, SEM system 400 adds the ability for advertiser system 430 to perform e-commerce on behalf of one or more merchants 410. A merchant 410 is a person, company or organization that sells products to shopper 140 across the Internet 110. Essentially, advertiser system 430 provides an electronic storefront that sells products to and collects payment from shopper 140 on behalf of merchant 410. When one or more products are sold, advertiser system 430 provides notice of the sale to merchant 410 which in turn ships the one or more purchased products to shopper 140. Advertiser system 430 retains a commission on each sale and pays merchant 410 the sale price minus its commission.

Advertiser system 430 operates three types of servers: an e-commerce web server 432, a search server 450, and a keyword management server 460. It will be appreciated by those skilled in the art that each of these servers can be configured as separate computer systems; or, alternatively, the servers can be configured as software modules that run in one of the other servers. For example, search server 450 can be configured as software modules that run in e-commerce web server 432. Additionally, multiple instances of each of these servers may be employed in order to meet performance and/or reliability/availability requirements.

E-commerce web server 432 operates an advertiser e-commerce website 435 that enables shopper 140 to browse, search for and purchase products across the Internet 110, using a standard web browser. Advertiser e-commerce website 435 displays and operates web pages that enable shopper 140 to select products and add them to a shopping cart. Shopper 140 can add additional products to the shopping cart and delete products from the shopping cart. When shopper 140 finishes shopping, he/she checks out and pays for the items in his/her shopping cart. Shopper 140 visits advertiser e-commerce website 435 using a web browser such as Microsoft Internet Explorer or Mozilla Firefox.

Additionally, advertiser e-commerce website 435 may include ads in web pages that it displays and operates. The ads may be sold directly by advertiser system 430 to other advertisers, i.e. to other companies or organizations that seek to place electronic ads. Alternatively, advertiser system 430 may become a SEM affiliate as previously described with reference to FIG. 2. In this case, ads included in web pages created by advertiser e-commerce website 435 are supplied by a SEM operator 115. It should be noted, that advertiser system 430 may become a SEM affiliate of a plurality of SEM operators 415, in which case it receives ads from the plurality of SEM operators.

As described previously with reference to FIG. 2, advertiser e-commerce website 435 displays advertiser landing pages 145 (FIG. 1) that include both product information 150 and ads 155.

In one embodiment, e-commerce web server 432 performs e-commerce on behalf of one or more merchants 410. In this case, each merchant 410 provides product data such as product number, product name, description, price, sizes, colors, and keywords to e-commerce web server 432. In turn, e-commerce web server 432 stores the product data in a product database 445.

As described in Table 1 below, a variety of actions performed by shopper 140 result in payments. Table 1 describes shopper 140 actions, the results of shopper 140 actions, payments made that generate advertising revenue, and payments that generate product (or “commission”) revenue.

TABLE 1
Shopper Actions that Result in Payments

| | | | Payments that | Payments that |
|---|---|---|---|---|
| | | | Generate | Generate |
| | | Result of Shopper | Advertising | Commission |
| Case | Shopper Action | Action | Revenue | Revenue |
| A. | Shopper 140 visits | Shopper is directed | Advertiser is | |
| | SEM operator | to advertiser landing | assessed a | |
| | website 118 (FIG. | page 145 (FIG. 1) at | keyword bid | |
| | 2), performs a | advertiser e- | amount by SEM | |
| | keyword search, and | commerce website | operator 115. | |
| | clicks on a | 435. | | |
| | sponsored ad that | | | |
| | appears in the | | | |
| | search results page. | | | |
| B. | Shopper 140 visits | Shopper is directed | Advertiser is | |
| | SEM affiliate website | to advertiser landing | assessed a | |
| | 225 (FIG. 2), | page 145 (FIG. 1) at | keyword bid | |
| | performs a keyword | advertiser e- | amount by SEM | |
| | search and clicks on | commerce website | operator 115. SEM | |
| | a sponsored ad that | 435. | operator 115 in | |
| | appears in the | | turn pays the | |
| | search results page. | | affiliate a share of | |
| | | | the revenue it | |
| | | | receives from | |
| | | | advertiser. | |
| C. | Shopper 140 | Advertiser e- | | Shopper pays |
| | purchases product | commerce website | | advertiser e- |
| | on advertiser e- | 435 takes payment | | commerce |
| | commerce website | from shopper; | | website 435 for |
| | 435. | advertiser fulfills the | | product. |
| | | order. | | |
| D. | Shopper 140 | Advertiser e- | | Shopper 140 |
| | purchases product | commerce website | | pays advertiser |
| | on advertiser e- | 435 takes payment | | e-commerce |
| | commerce website | from shopper and | | website 435 for |
| | 435. (Case where | notifies merchant | | product. |
| | product is being sold | 410 of sale. | | Advertiser |
| | on behalf of | Merchant 410 fulfills | | retains |
| | merchant 410.) | the order. | | commission and |
| | | | | pays the rest to |
| | | | | merchant 410. |
| E. | Shopper 140 clicks | Shopper 140 is | Second advertiser | |
| | on sponsored ad on | directed to second | is assessed a | |
| | first advertiser e- | advertiser landing | keyword bid | |
| | commerce website | page. | amount by SEM | |
| | 435. (Case where | | operator 115.. | |
| | first advertiser is a | | SEM operator 115 | |
| | SEM operator | | pays share of bid | |
| | affiliate.) | | amount to first | |
| | | | advertiser (who is | |
| | | | a SEM affiliate). | |
| F. | Shopper 140 clicks | Shopper 140 is | Second advertiser | |
| | on sponsored ad on | directed to second | pays first | |
| | first advertiser e- | advertiser's landing | advertiser agreed | |
| | commerce website | page. | to amount for ads | |
| | 435. (Case where | | that it displays on | |
| | first advertiser sells | | advertiser e- | |
| | ads directly to | | commerce website | |
| | second advertiser.) | | 435. | |

E-commerce web server 432 provides a database manager 440 that stores product information into and retrieves product information from a product database 445. Product database 445 refers to a plurality of physical storage media that store product information. Physical storage media may include disk drives, tape drives, and removable media such as CD RW drives.

E-commerce web server 432 interoperates with search server 450 to enable shoppers 140 to search for products. Search server 450 attempts to match search terms entered by shopper 140 with keywords included in the product information stored in product database 445. Search server 450 retrieves product information corresponding to the matching keywords.

Keyword management server 460 acquires keywords, and manages and supplies keywords, ads and bids for keywords to SEM operator 115. It should be noted that keyword management server 460 may supply keywords, ads and bids to a plurality of SEM operators 415.

Keyword management server 460 includes a keyword database 490 and a tracking database 495. Keyword database 490 refers to keyword data stored on physical storage media. Physical storage media may include disk drives, tape drives, and removable media such as CD RW drives. Tracking database 495 refers to tracking and statistical data stored on physical storage media. Physical storage media may include disk drives, tape drives, and removable media such as CD RW drives. It will be appreciated by those skilled in the art that keyword database 490 and tracking database 495 can share the same physical storage media. For example, keyword data can be stored on the same storage device that tracking data is stored on.

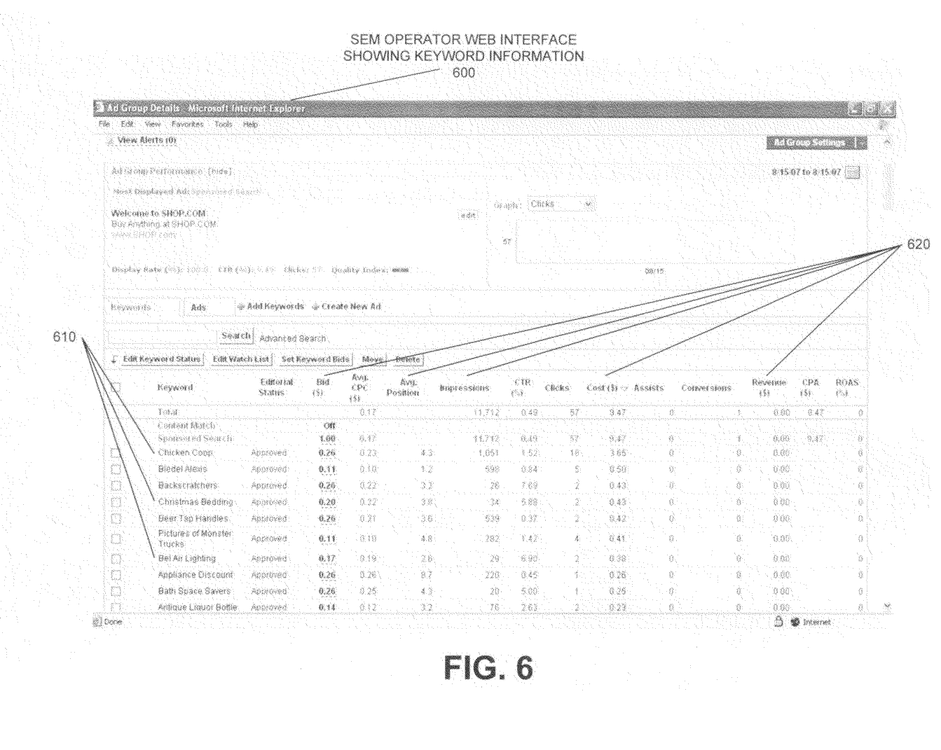

Keyword management server 460 includes a keyword acquirer 465. Keyword acquirer 465 obtains keywords and historical keyword performance data from several sources and stores the data in a keyword database 490. Sources for keywords may include: (1) shopper 140 who visits advertiser e-commerce website 435 and performs keyword searches; (2) merchant 410 who supplies product information including keywords; and (3) SEM operator 115 who provides keyword performance data. An example of the information about keywords provided by SEM operators 415 is given in FIG. 6. Some SEM operators 415 also provide lists of keywords that are used in their system. Keyword management server 460 subsequently analyzes and tests keywords for prospective bids.

In one embodiment, merchant 410 supplies keywords along with product information to e-commerce web server 432, and keyword acquirer 465 obtains the merchant's keywords and stores them in keyword database 490. If no keywords are supplied by merchant 410 then keyword acquirer 465 extracts keywords from the product information supplied by merchant 410 and stores the keywords in keyword database 490.

Keyword database 490 stores historical information about each keyword for each SEM operator to which keyword management server 460 provides bids. Information stored in keyword database 490 may include the current bid placed by keyword management server 460, average cost per click (CPC), average position of the sponsored ad, the number of times the sponsored ad was viewed during the period (commonly referred to as “impressions”), the click through ratio (CTR) of the sponsored ad, the total number of clicks on the ad during the period, and the total amount paid by the advertiser to the SEM operator. Keyword database 490 stores data obtained from SEM operator 115 as well as data obtained from e-commerce web server 432. Typically, keyword acquirer 465 downloads reports from each SEM operator daily so that daily performance results per keyword can be computed. Additionally, keyword database 490 stores tables of keywords and their corresponding bids for each period and each SEM operator.

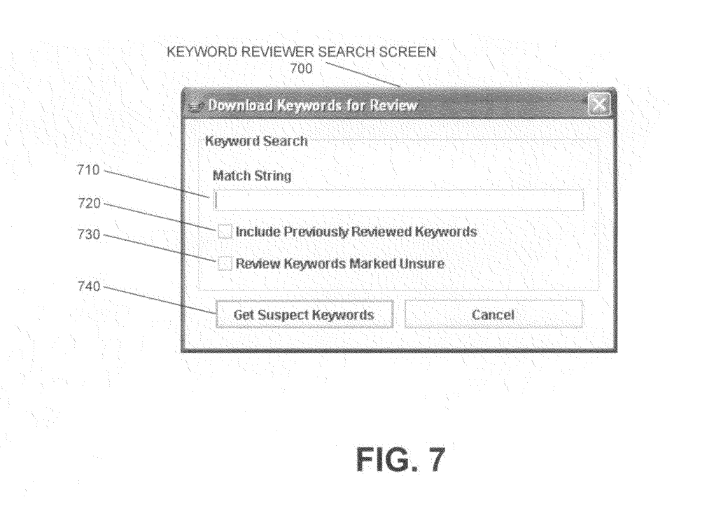

Keyword management server 460 includes a web-based keyword review tool 470 that enables a keyword reviewer 420 to evaluate keywords stored in keyword database 490. Keyword reviewer 420 is an individual that uses keyword review tool 470 to select, reject and categorize keywords. Keyword review tool 470 is further described below with reference to FIG. 7.

A keyword tracker 475 obtains, organizes and stores information concerning actions performed by shopper 140 on advertiser e-commerce website 435 into a tracking database 495. Keyword tracker 475 stores data related to “sessions” where a session refers to the sequence of actions performed by shopper 140 from the time he/she arrives at advertiser e-commerce website 435 as a result of clicking on a keyword ad until he/she leaves advertiser e-commerce website 435 for another website or until the session times out due to inactivity. For each session, the session data given in Table 2 below is stored in a tracking database 495.

TABLE 2
Session Data in Tracking Database

| Item | Description |
|---|---|
| Keyword | The keyword itself, i.e. the keyword for which shopper 140 clicked on a |
| | corresponding sponsored ad. |
| Source ID | A descriptor that indicates where the keyword was used. In one |
| | embodiment the source id identifies the SEM operator 115 that |
| | supplied the keyword and ad. In one embodiment the source id |
| | provides more granular information and refers to both the SEM |
| | operator 115 and the actual website where shopper 140 performed |
| | the keyword search and subsequently clicked on a sponsored ad. |
| Date and Time of | The date and time when the session began. |
| session | |
| Commission | The amount of money generated and retained by advertiser due to a |
| revenue | product purchase made by shopper 140 on advertiser e-commerce |
| | website 435 during the session or as a consequence of the session. |
| | For example, if the product purchased is supplied by a merchant 410, |
| | then the commission revenue is the amount that advertiser keeps after |
| | paying merchant 410. |
| Ad revenue | The amount of money generated and retained by advertiser as a result |
| | of shopper 140 clicking on an ad on advertiser e-commerce website |
| | 435. |

Information stored in tracking database 495 is used by a bid calculator 477 to analyze keyword bids.

Bid calculator 477 uses data stored in keyword database 490 and in tracking database 495 to update bids on keywords. Bid calculator 477 updates bids that have been placed with each SEM operator 115 at regular periods. The length of a period is optimally determined by the frequency with which SEM operator 115 makes available updated keyword data to advertiser system 430. For example, if SEM operator 115 updates its keyword data daily then bids are updated daily. Bids are typically updated daily, weekly, biweekly or monthly. At the close of each period, bid calculator 477 calculates a new bid for each keyword using a “bidding algorithm.” The bidding algorithm is described in more detail with respect to FIG. 9. Using the bidding algorithm, bid calculator 477 creates three tables of keywords, a Delete Table, an Update Table, and a Keep Table. The Delete Table lists each keyword for which a bid was submitted to SEM operator 115 but where no bid will be submitted for the next period. The Update Table lists all keywords and their corresponding bids for the next period where the bid for the next period has changed relative to the bid for the current period. The Keep Table lists all keywords whose bids remain unchanged for the next period. Bid calculator 477 stores the three tables of keywords and their corresponding bids for the next period into keyword database 490.

After bid calculator 477 determines the new bids, creates the Delete, Update, and Keep tables for the next period, and stores the tables into keyword database 490, a bid distributor 478 provides the keyword bids for the next period to SEM operator 115. Each SEM operator 115 requires that bids be updated using a specific method. Thus, a bid distributor 478 must understand and perform the method required by each SEM operator 115. For example, some SEM operators 415 allow bid distributor 478 to incrementally adjust bids; in this case, bid distributor 478 only provides bids from the Delete and Update tables, i.e. those that have changed relative to the last period. Some SEM operators 115 require that bid distributor 478 update all keywords at one time.

An application server 480 is a software module that runs on keyword management server 460. It provides services that the various keyword management server 460 software modules, including keyword acquirer 465, keyword review tool 470, keyword tracker 475, bid calculator 477, and bid distributor 478, can call. These services may include communication protocols such as HTTP and email (SMTP), database access, security, resource pooling, messaging, load-balancing and high-availability capabilities, GUI rendering services, thread management and other system services. The application server and its clients communicate over a well defined API which exposes the business logic the client needs. The application server manages its own resources and shields clients from the underlying operating system platform.

Additionally, keyword management server 460 provides a database manager 485 that provides access to and from keyword database 490 and tracking database 495.

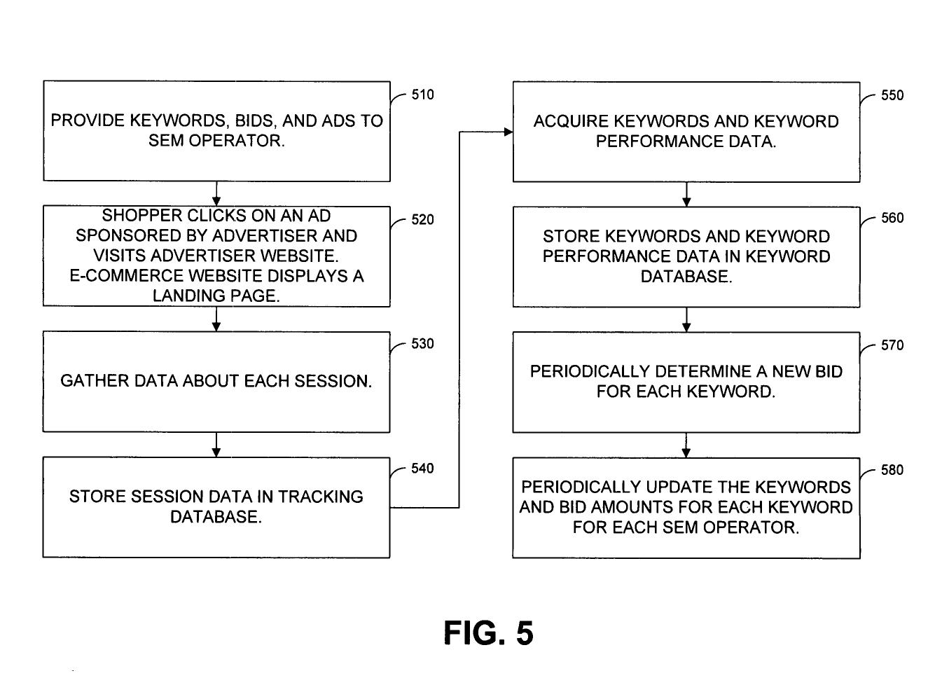

Now reference is made to FIG. 5, which is a simplified flowchart of an overall method for updating keyword bids, in accordance with an embodiment of the present invention. The method of FIG. 5 is performed by an advertiser system, such as advertiser system 430 of FIG. 4. At Step 510 the advertiser system provides keywords, a bid for each keyword, and an ad for each keyword to one or more SEM operators 115. At Step 520, while visiting a SEM operator website 118 or a SEM affiliate website 225 a shopper 140 clicks on an ad sponsored by advertiser system 430 and consequently visits advertiser e-commerce website 435. Advertiser e-commerce website 435 displays a landing page that includes product information and ads.

At Step 530 session data is gathered for each shopper session, also referred to as a “session” or “visit”. Session data includes the keyword corresponding to the ad that shopper 140 clicked which resulted in their visit to advertiser e-commerce website 435, a source ID, a date of the session, a commission revenue and an ad revenue. At Step 540 session data is stored in a tracking database, such as tracking database 495 of FIG. 4.

At Step 550, on an ongoing basis advertiser system 430 acquires keywords from shoppers 140 that perform keyword searches on advertiser e-commerce website 435 and from each SEM operator 115. In one embodiment, advertiser system 430 also acquires keywords from merchants 410. Additionally, advertiser system acquires keyword performance data from SEM operators 115. At Step 560 keywords and keyword performance data is stored in a keyword database, such as keyword database 490 of FIG. 4.

At Step 570 advertiser SEM system periodically determines a new bid for each keyword. Step 570 is described in detail below with reference to FIGS. 9-11.

At Step 580 advertiser system 430 periodically updates the keywords and keyword bid amounts for each SEM operator 115.

Now reference is made to FIG. 6, which is an exemplary web user interface 600 that shows the keyword information provided by a search engine marketing operator, in accordance with an embodiment of the subject invention. On the left side, exemplary SEM operator web interface 600 lists keywords 610 in successive rows for which keyword management server 460 has placed bids. For each keyword, columns 620 provide information about the keyword performance including the current bid placed by keyword management server 460, average cost per click paid by advertiser 105 to SEM operator 115, average position of the sponsored ad in search results pages provided by SEM operator 115, the number of impressions the keyword ad received during the period, the click through ratio of the sponsored ad, the total number of clicks on the ad during the period, and the total amount paid by the advertiser to SEM operator 115.

Reference is now made to FIG. 7, an exemplary web user interface used by a keyword reviewer to select keywords, in accordance with an embodiment of the subject invention. Keyword reviewer 420 (FIG. 4) uses a keyword reviewer search screen 700 to search for one or more keywords that will then be retrieved by keyword review tool 470 and made available for review. Keyword reviewer 420 enters a single keyword into a match string 710 entry field. An entire word can be entered, e.g. “sweater”. In addition, a wildcard character, “*”, can be entered anywhere in the keyword, e.g. “*sweater”, “sweater*”, “swe*ter” which may result in more than one match. Additionally, keyword reviewer 420 may include previously reviewed keywords using a checkbox 720. Additionally, keyword reviewer 420 may include keywords that have been previously designated “unsure” using checkbox 730. Typically, a keyword reviewer 420 designates a keyword as “unsure” if they wish to perform more research on the keyword of if they want a supervisor to review the keyword. When keyword reviewer 420 has completed specifying the search, he/she clicks on “Get Suspect Keywords” 740.

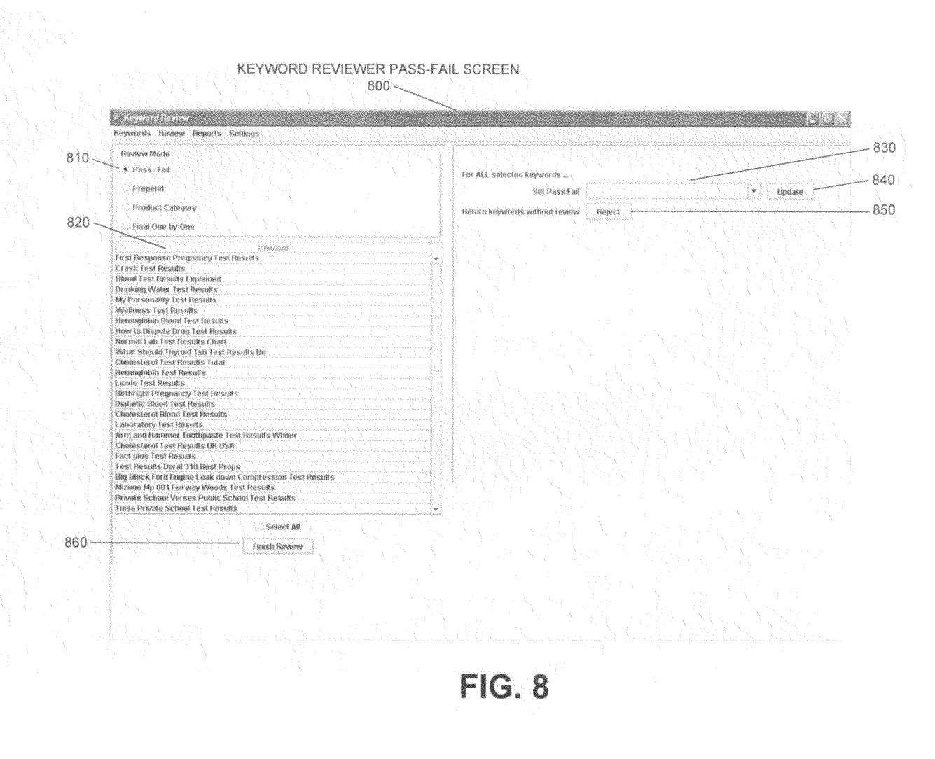

At this point, keyword review tool 470 retrieves the keywords specified in the search and displays a keyword reviewer pass-fail screen 800, depicted in FIG. 8.

Now reference is made to FIG. 8, an exemplary web user interface used by a keyword reviewer to review keywords and approve or disapprove them, in accordance with an embodiment of the subject invention. Keyword reviewer 420 may switch to another review mode, either prepend, product category, or final one-by-one, using review mode radio button 810. Keyword reviewer 420 selects one or more keywords from a keyword list 820 on the left side of the screen. Then keyword reviewer 420 selects one of the choices from a pass/fail list 830. Keyword reviewer can select “Pass” or “Fail” from the pass/fail list 830. Each of the “Fail” selections includes a reason for failure. If keyword reviewer 420 fails the keyword, he/she selects the item from the list with the most appropriate reason for failure.

### Reasons for Failure Include:

Contextually inappropriate language
Not related to a product sold by advertiser
Failure requested by a merchant
Completely inappropriate language, i.e. inappropriate in any context
Failure requested by entity other than a merchant
Merchant not on site, i.e. the keyword relates to a product from a merchant not represented by advertiser e-commerce website 435.
   After keyword reviewer 420 makes the appropriate selection from pass/fail list 830, he/she clicks on “Update” 840 to accept the selection, or “Reject” 850 to reject the selection. If keyword reviewer 420 selects “Reject,” the keywords are eliminated from the list; it is as though they were never selected for reviewing. Keyword reviewer 420 may then select additional keywords from keyword list 820 and repeat the pass/fail process

Typically, once keyword reviewer 420 completes the pass/fail process, he/she selects the “Prepend” review mode. Keyword reviewer 420 uses the Prepend review mode to assign prepend terms to any of the keyords in keyword list 820. Prepend terms include “a”, “an”, or “the”. A prepend term may make the keyword read better grammatically with ad copy. Typically, once keyword reviewer 420 completes the prepend process, he/she selects the “Product Category” review mode. Keyword reviewer 420 uses the Product Category to review mode to assign appropriate product categories to any of the keywords in keyword list 820. Once keyword reviewer 420 completes assigning product categories he/she selects the “Final One-by-One” review mode. Keyword reviewer 420 uses the Final-One-by-One review mode to adjust the selections made in each of the other three review modes: Pass/Fail, Prepend, and Product Category. When keyword reviewer finishes processing the keywords in keyword list 820 he/she clicks “Finish Review” 860.

Reference is now made to FIG. 9, a flowchart describing the processing steps performed by a keyword bidding algorithm to determine the amount to bid for a keyword, in accordance with an embodiment of the subject invention. Bid calculator 477 performs this algorithm periodically for each SEM operator that it supplies keyword bids to. The algorithm calculates a bid for each keyword in keyword database 490. In the following discussion, NewBid refers to a bid that is being calculated by the keyword bidding algorithm in a series of steps. CurrentBid refers to the bid in place for the current period or for the recently completed period, which may be replaced by NewBid.

The keyword bidding algorithm automates the computation of a bid for a keyword. The algorithm uses keyword data stored in keyword database 490 and tracking data stored in tracking database 495 to make a tradeoff between increased shopper traffic that results from increasing bids for keywords, and decreased profitability that results from paying a higher bid amount to SEM operator 115 for each click on a sponsored ad. To perform this tradeoff, the keyword bidding algorithm enables advertiser 105, who operates keyword management server 460, to establish an aggressiveness factor which defines the profitability goal for keyword purchases. For example, an aggressiveness factor of 0.7 means that advertiser 105 is willing on average to pay 70% of average revenue generated by the keyword to SEM operator 115 for traffic that it generates. Thus, an aggressiveness factor of 0.7 corresponds to a profitability goal of 30%. If the aggressiveness factor for a keyword is increased then the amount that advertiser 105 is willing to pay to SEM operator 115 for keyword bids is correspondingly increased. This results in better placement of the corresponding ads by SEM operator 115 and hence increased traffic to e-commerce web server 432 due to increased ad clicks by shopper 140.

However, when a new keyword is introduced, the traffic that the corresponding ad at a particular bid amount will generate is not yet known. The keyword bidding algorithm provides a method to “tune” the bid over a series of time periods in order to reach the desired profitability goal. Similarly, external conditions may change in a way that causes traffic to vary over time. The keyword bidding algorithm adjusts the bid to account for external factors over a series of time periods to reach the desired profitability goal. If the profitability of a keyword falls below an established threshold then the keyword bidding algorithm deletes the bid.

Bid calculator runs the keyword bidding algorithm once for each SEM operator, to update all keyword bids each period. To start, bid calculator 477 selects a SEM operator 115 and initiates the keyword bidding algorithm. It is noted that any historical data used in the keyword bidding algorithm, e.g. ad revenue, commission revenue or session data, pertains to said SEM operator 115.

At Step 905 session data for said SEM operator 115 is retrieved from tracking database 495 and organized by keyword. The data is organized into K time periods, where the time period is established as previously discussed.

At Step 910, a bid limit named MaxBid is calculated. MaxBid is applied later in the algorithm to limit or cap the bid. In one embodiment, MaxBid is defined as:

multiplier*(total revenue for the previous period)/(total session count for the past period),

where the multiplier is a positive real value, generally in the range of one to two (1 to 2), total revenue refers to all revenue resulting from sessions for all keywords during the previous period whose Source ID in tracking database 495 corresponds to said SEM operator 115, and session count is the total number of sessions for all keywords whose Source ID corresponds to said SEM operator and whose Date of Session falls during the period.

The keyword bidding algorithm tests various bid amounts in a methodical way in attempting to determine a bid; thus, it is likely that some bid amounts will prove unprofitable. Therefore, MaxBid limits the potential for unprofitable bid amounts. For example, if the average revenue expected per session, as represented by the total revenue divided by the total number of sessions across all keywords, is $0.50, then when the bid amount is set to $1 for a keyword, i.e. twice the average expected revenue across all keywords, the operator of keyword management server 460 loses $0.50 on average for each session that results from a shopper 140 clicking on an ad corresponding to said keyword. While increasing the bid amount for a keyword improves the position of the corresponding ad supplied by SEM operator 115 and therefore generates more sponsored ad clicks and traffic, this may unacceptably increase the financial loss.

At Step 915, the next keyword is retrieved. In one embodiment keywords are processed alphabetically.

At Step 920 the “revenue per click” (RPC) value is calculated for the keyword. The RPC calculation uses “time weights” that vary for each period. In one embodiment, the time weights are stored in a table. The most recent period has the greatest time weight with the values decreasing for each successively older period. For example, if two years of preceding data are used and time periods are two weeks then K, the number of periods, equals 52; whereas, if one month periods are employed then K=24. One formula for computing weights can be stated as follows: w(i)=(i/K)/((K+1)/2), where w(i) are the weights for each period, i, such that i=K for the most recent period, i=K−1 for the next oldest period, and i=1 for the oldest period.

To compute RPC, first the total revenue for each period is multiplied by the period's time weight and the weights are summed for each period to create the “weighted total revenue.” The total revenue for each period is the sum of the commission revenue and ad revenue, described previously. Thus, weighted total revenue can be defined as:

$$Weighted total revenue = {\sum }_{i = 1}^{K} ( w ( i ) * ( AR ( i ) + CR ( i ) ) ) ,$$

where w(i) is the time weight for period i, AR(i) is the ad revenue for period i, and CR(i) is the commission revenue for period i.

Next, the “session count” for each period, i.e. the number of sessions that occurred during the period as a result of shoppers 140 clicking on the keyword, is multiplied by the period's time weight and the results are summed to create the weighted session count. This can be stated as:

$$Weighted session count = {\sum }_{i = 1}^{K} ( w ( i ) * SessionCount ( i ) ,$$

where w(i) is the time weight for period i and SessionCount(i) is the number of sessions that occurred during time period i as a result of shoppers 140 clicking on the keyword.

Finally, the “revenue per click”, or RPC, for the keyword is computed as:

Weighted total revenue/Weighted session count

In the following steps, two values, MinCPC and MaxCPC are used. The minimum cost per click (MinCPC) is the minimum bid that the keyword bidding algorithm will compute. The maximum cost per click (MaxCPC) is the maximum bid that the keyword bidding algorithm will compute. MinCPC is set by the advertiser 105, who operates keyword management server 460, for each SEM operator 115. For example, some SEM operators 115 require that the minimum bid be at least $0.05. In this case, MinCPC may be set to $0.05 for these SEM operators 115. MaxCPC is also set by said advertiser 105 based on business objectives. In one embodiment, MinCPC and MaxCPC can be varied for each keyword.

At Step 925 an adjusted revenue per click (adjRPC) value is calculated for the keyword by applying the aggressiveness factor to the previously calculated revenue per click (RPC) as follows:

adjRPC=RPC*Aggressiveness Factor,

where the aggressiveness factor is a positive scalar value, as described above. As previously discussed, the aggressiveness factor allows keyword management server 460 to control a tradeoff between increased traffic and decreased profitability due to higher bid fees paid to SEM operators 115.

At Step 930 the lower bound, MinCPC, is applied such that if the RPC is greater than or equal to MinCPC and adjRPC is less than MinCPC, then adjRPC is set to MinCPC. This ensures that the adjusted keyword bid amount (adjRPC) falls into an acceptable range and hence the keyword will not be deleted.

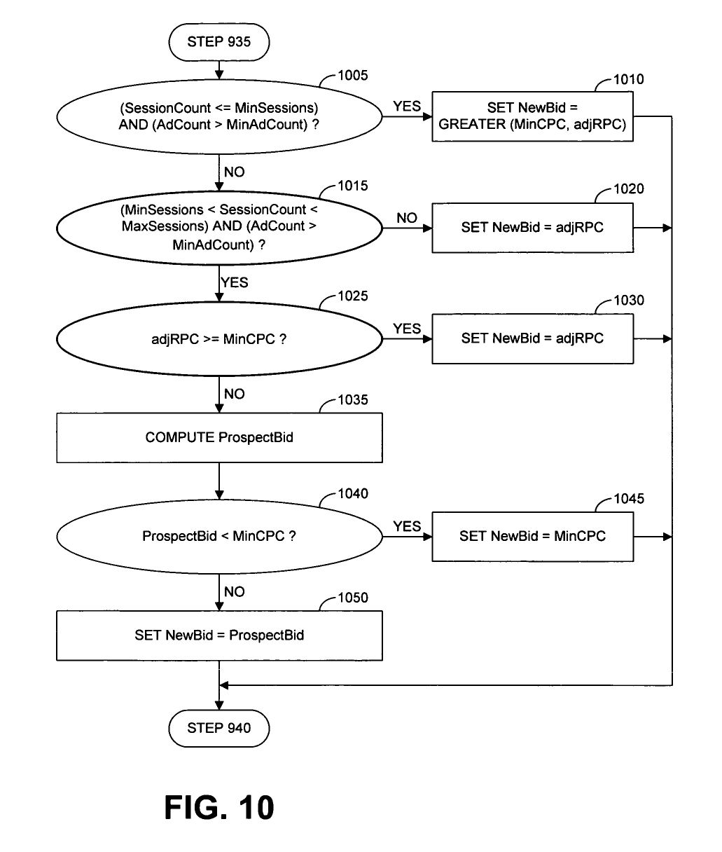

At Step 935 a prospecting algorithm is performed which sets NewBid. Step 935 is described in detail below with reference to FIG. 10. The prospecting algorithm methodically adjusts the bids for keywords that have not statistically proven themselves as either profitable or unprofitable so as to explore, or prospect, for a well performing bid amount.

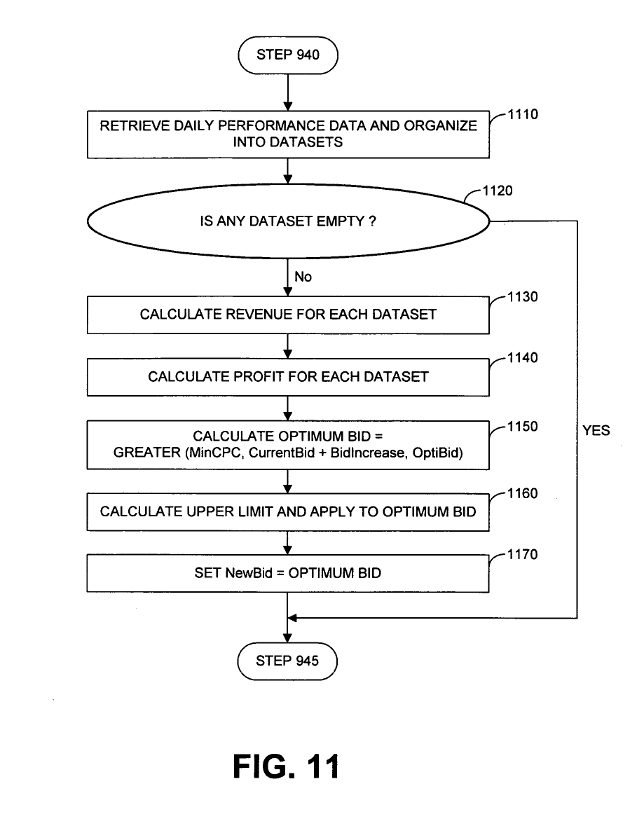

At Step 940 a profitability algorithm is performed which may set a new value for NewBid. A profitability algorithm is described in detail below with reference to FIG. 11.

At Step 945 several upper bounds are applied to NewBid to ensure that the keyword bid is not too high. In one embodiment, three upper bound bid limits are applied. The first upper bound limits the bid increase to five cents ($0.05) per period. Thus if NewBid exceeds CurrentBid, where CurrentBid is the bid for the current period, by more than five cents then NewBid is set to CurrentBid+$0.05. Next, if NewBid exceeds MaxBid, as calculated in Step 910, then NewBid is set to MaxBid. Finally, if NewBid exceeds MaxCPC then NewBid is set to MaxCPC.

At Step 950, the bidding algorithm stores the keyword and the new bid in one of three tables that it creates. These tables are used by bid distributor 478 to prepare the next submission of keywords and bids for SEM operator 115. If NewBid is less than the minimum bid allowed by SEM operator 115 then the keyword and NewBid are added to the Delete table. No new bid will be placed for this keyword. In one embodiment, the keyword is deleted from keyword database 490. In another embodiment, the keyword remains in keyword database 490 but is deactivated. When a keyword is deactivated no new bid will be placed until the keyword is reactivated by advertiser 105. In one embodiment, a keyword is reactivated if one of the following conditions is detected: (1) the bidding algorithm logic changes and the new bid for the keyword calculated by the bidding algorithm is over the minimum bid; (2) the keyword has been deactivated no more than once due to low bids, and was last deactivated over 90 days ago; (3) the keyword has been deactivated no more than twice due to low bids, and was last deactivated over 180 days ago; or (4) the keyword has been deactivated no more than three times due to low bids, and was last deactivated over 360 days ago.

If NewBid is not equal to CurrentBid, but is greater than or equal to the minimum allowed bid, then the keyword and NewBid are added to the Update table. If NewBid is the same amount as CurrentBid then the keyword and NewBid are added to the Keep table. In this case the new bid remains unchanged from the current bid.

At Step 955 a determination is made as to whether all keywords have been processed. If not, then control is passed back to Step 915 and the next keyword is processed. If all keywords have been processed then the algorithm terminates.

Now reference is made to FIG. 10, a flowchart describing the processing steps performed by a keyword prospecting algorithm to determine the amount to bid for a keyword, in accordance with an embodiment of the subject invention. The flowchart of FIG. 10 corresponds to step 935 from FIG. 9. The keyword prospecting algorithm calculates a bid for a keyword. All keywords are run through the keyword prospecting algorithm. The keyword prospecting algorithm employs several values, including: (1) SessionCount which refers to the total of all sessions for the keyword that occurred during the previous period; (2) MinSessions which is a lower threshold on the SessionCount; (3) MaxSessions is an upper threshold on SessionCount; (4) AdCount which is the average number of ads 130 that shoppers 140 clicked on at SEM operator website 118 for the keyword during the previous period; and, (5) MinAdCount which is pre-set for each SEM operator and serves as a lower threshold for AdCount. The threshold MinAdCount enables the advertiser to establish a minimum goal for the number of ad clicks by shoppers 140 per period for the keyword.

At Step 1005 a determination is made as to whether two conditions are met: first, is SessionCount less than or equal to MinSessions, and second, is AdCount greater than MinAdCount? If both conditions are met, then at Step 1010 NewBid is set to the greater of MinCPC and adjRPC.

If either of the two conditions is not met, then at Step 1015 a determination is made as to whether two conditions are met: first is SessionCount greater than MinSessions and less than MaxSessions, and second, is AdCount greater than MinAdCount? If either of these conditions is not met then at Step 1020 NewBid is set to adjRPC.

At Step 1025 a determination is made as to whether adjRPC is greater than or equal to MinCPC. If so, then at Step 1030 NewBid is set to adjRPC. If not, then at Step 1035 a value named ProspectBid is computed as follows:

ProspectBid=adjRPC+MinCPC*(MaxSessions−SessionCount)/(MaxSessions−MinSessions)

At Step 1040 a determination is made as to whether ProspectBid is lower than MinCPC. If so, then at Step 1045 NewBid is set to MinCPC. If not then at Step 1050 NewBid is set to ProspectBid.

Now reference is made to FIG. 11, a flowchart describing the processing steps performed by a keyword profitability algorithm to determine an optimal bid for a keyword, in accordance with an embodiment of the subject invention. The flowchart of FIG. 11 corresponds to Step 940 from FIG. 9. The keyword profitability algorithm is performed relative to a single keyword and relative to a single SEM operator. In some cases, the keyword profitability algorithm calculates a new bid for a keyword. The keyword profitability algorithm uses keyword performance data stored in keyword database 490 and tracking database 495 to determine an optimal bid based on recent keyword performance.

At Step 1110, daily performance data for said keyword for the previous P days is retrieved from keyword database 490 and tracking database 495. Keyword performance data retrieved from keyword database 490 includes the number of clicks received daily on the keyword ad and the total cost of the keyword each day, i.e. the amount paid by the advertiser to the SEM operator each day for the keyword. Session data retrieved from tracking database 495 includes the daily commission revenue for P days and the daily ad revenue for P days. The performance data for P days is then organized into M datasets, each representing P/M days. For purposes of simplicity, in the following discussion of the keyword profitability algorithm P=9 and M=3 will be used such that the first dataset contains data from 1-3 days ago, dataset 2 contains data from 4-6 days ago, and dataset 3 contains data from 7-9 days ago. It will be appreciated by those skilled in the art that the numbers P and M may be flexibly defined and changed at will.

At Step 1120 a determination is made as to whether any of the three datasets is empty. If any dataset is empty, then the algorithm terminates and no bid is calculated by the keyword profitability algorithm. Reasons for which this might occur include inter alia (1) that no shopper clicked on the keyword during a three day time interval represented by the dataset, or (2) that a keyword is less than nine days old. If data is present for each of the three datasets then processing continues at Step 1130.

At Step 1130 the keyword's revenue for each of the three datasets is calculated as:

$$Revenue for dataset i = {\sum }_{j = 1}^{3} ( AR ( 3 * ( i - 1 ) + j ) + CR ( 3 * ( i - 1 ) + j ) ) ,$$

where AR(k) is the ad revenue for day k due to said keyword, and CR(k) is the commission revenue for day k due to said keyword.

At Step 1140 the keyword's profit for each of the three datasets is calculated as: Profit for dataset i=Revenue for dataset i−Cost for dataset i, where the revenue for dataset i was calcuated previously in Step 1130. The cost for dataset i can be formulated as:

$$Cost for dataset i = {\sum }_{j = 1}^{3} Cost ( 3 * ( i - 1 ) + j ) ,$$

where Cost(k) is the cost of the keyword per day.

At Step 1150 an optimum bid for the keyword is calculated as the greater of three values: MinCPC, CurrentBid+BidIncrease, and OptiBid. BidIncrease is the maximum increase in the bid amount from one period to the next allowed by advertiser and OptiBid is an estimate of an optimal bid amount based on available historical data. One embodiment of the computation of OptiBid is provided in Listing 1 at the end of this specification.

Referring to Listing 1, BidIncrease as previously defined is set to $0.05 and MaxBid is set to the value calculated in Step 910. Two values are calculated for each of the three datasets. Bidi represents the cost per click for dataset i and Profiti represents the profit per click for dataset i. Each pair of values can be defined as a point in a two dimensional graph where the horizontal axis represents bid value and the vertical axis represents profit value. In the algorithm provided in Listing 1, a parabolic curve is fitted to the three points. The algorithm calculates the summit point of the parabola. Then, depending on whether the parabola is convex or concave and taking into account the MinCPC and MaxBid constraints, OptiBid is selected as either MinCPC, Bid3+BidIncrease, or the summit point.

In another embodiment, OptiBid is defined as:

OptiBid=Agressiveness Factor*RPC(MaxProfit), where

RPC(MaxProfit) is the revenue per click for the data set with the highest profit as calculated in Step 1140. RPC(i), the revenue per click for said keyword for dataset i can be calculated as:

RPC(i)=Revenue for dataset i/SessionCount for dataset i

It will be appreciated by those skilled in the art that there are many algorithms that may be used to compute Optibid, and more generally an optimum bid based on historical data.

At Step 1160 an upper limit is calculated and applied to the optimum bid as calculated in the preceding step. Thus, if the optimum bid exceeds the upper limit, then the optimum bid will be set to the upper limit. In one embodiment, the upper limit is defined as twice the average revenue per click over the past nine days. This can be formulated as:

$$Upper limit = 2 * {\sum }_{i = 1}^{3} RPC ( i ) / 3 ,$$

where as previously noted, RPC(i) is the average revenue per click for dataset i.

At Step 1170 NewBid is set to the optimum bid and the keyword profitability algorithm terminates.

Although the specific embodiment described above relates to the formulation of keyword bids by advertisers that provide websites that offer both e-commerce and advertising capability, the present invention is independent of the mechanism(s) by which the advertiser website 142 generates revenue as a consequence of website traffic. For example, the website may inter alia sell products, provide online advertising, or generate leads on a paid basis. The present invention can be employed as long as the mechanism generates quantifiable revenue to the advertiser. For example, the present invention can be used by websites that perform lead generation. In this regard, the website generates revenue by obtaining leads and subsequently selling the lead information to inter alia advertisers or vendors. In this regard, lead information refers to contact information such as inter alia name and email address for website visitors.

Although the specific embodiment described above describes an advertiser system that provides the ability to perform e-commerce on behalf of one or more merchants 410, the present invention applies equally to the case where the advertiser system does not perform e-commerce on behalf of merchants.

Although the specific embodiment described above describes an advertiser system that includes a search engine, the present invention applies equally to the case where the advertiser system does not include a search engine. For example, the advertiser system might include a website that employs static web pages and does not offer product search capability.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Thus it may be appreciated that the present invention is advantageous for use with auction and e-commerce systems in which bids are submitted on a recurring basis, in addition to search marketing systems, including ticketing systems, real estate sales, and the like. Accordingly, the specification and drawings are to be regarded in an illustrative rather than a restrictive sense.

Listing 1

```
BidIncrease = .05 (represents 5 cents)
MaxBid = as previously calculated
Bid1 = Average cost per click (CPC) for dataset 1
Profit1 = Average profit for dataset 1
Bid2= Average CPC for dataset 2
Profit2 = Average profit for dataset 2
Bid3 = Average CPC for dataset 3
Profit3 = Average profit for dataset 3
ACoeff = ((Profit2−Profit3)*(Bid1−Bid2)−(Profit1−Profit2)*
(Bid2−Bid3))/((Bid2−Bid3)*(Bid1−Bid2)*(Bid3−Bid1))
BCoeff = (Profit2−Profit3)/(Bid2−Bid3)−ACoeff*(Bid2+Bid3)
CCoeff = Profit1−ACoeff*Bid1*Bid1−BCoeff*Bid1
If ACoeff = 0
{
    If BCoeff<=0 and BCoeff*MinCPC+CCoeff>0
        OptiBid = MinCPC:
    Else if BCoeff>0 and BCoeff*(Bid3+BidIncrease)+CCoeff>0:
        OptiBid = Bid3+@BidIncrease
}
If ACoeff > 0
(
    If (−BCoeff/ACoeff >= MaxBid+MinCPC and
ACoeff*MinCPC*MinCPC+BCoeff*MinCPC+CCoeff > 0):
        OptiBid = MinCPC
    Else if (−BCoeff/ACoeff < MaxBid+MinCPC
    and ACoeff*(Bid3+BidIncrease)*(Bid3+BidIncrease) + BCoeff *
(Bid3 + BidIncrease) + CCoeff>0):
        OptiBid = Bid3 + BidIncrease
}
If ACoeff < 0
{
    If (−BCoeff / (2*ACoeff) <= MinCPC and ACoeff * MinCPC *
    MinCPC+BCoeff*MinCPC+CCoeff>0):
        OptiBid = MinCPC
    Else if (−BCoeff/(2*ACoeff) > MinCPC and ACoeff*−
BCoeff/(2*ACoeff)*− BCoeff/(2*ACoeff)+BCoeff*−BCoeff/
(2*ACoeff)+CCoeff > 0):
        OptiBid = −BCoeff/(2*ACoeff)
}
Else, no OptiBid for this keyword.
END
```

What is claimed is:

1. A method for search engine keyword bidding, comprising:
(a) providing a search engine that is used by shoppers to search for products and services, wherein the search engine receives at least one designated keyword as input and generates a ranked list of at least one ad related to the at least one designated keyword as output, wherein each ad is sponsored by an advertiser and has a bid amount associated therewith and includes a link to a landing page of an advertiser's website, and wherein higher ranked ads are more prominently displayed by the search engine and generally generate more revenue than lower ranked ads;
(b) maintaining by an advertiser a keyword database used by the search engine, the keyword database comprising records, each record including (i) a designated keyword, (ii) an ad sponsored by the advertiser that is displayed by the search engine in response to a search using the designated keyword, and (iii) a bid amount that is paid by the advertiser to an operator of the search engine as a fee each time a shopper clicks on the advertiser's sponsored ad that is displayed by the search engine in response to the shopper's search using the designated keyword;
(c) collecting by the advertiser statistics for revenue generated during each Internet session on the advertiser's website that begins when a shopper visits the advertiser's landing page in response to the shopper clicking on an advertiser's sponsored ad;
(d) maintaining by the advertiser a tracking database comprising records of Internet sessions for a plurality of shoppers, each record including (i) a designated keyword corresponding to the sponsored ad that the shopper clicked on, (ii) a time and date of the shopper's Internet session, and, (iii) revenue generated for the advertiser during the shopper's Internet session;
(e) periodically revising by the advertiser a bid amount for a keyword in the keyword database, based on total revenue in the tracking database corresponding to the keyword over a given time period.

2. The method of claim 1 further comprising adding keywords to the keyword database based on keywords provided by the search engine.

3. The method of claim 1 wherein the advertiser's website is an e-commerce website for a plurality of merchants, at which shoppers purchase merchants' products related to sponsored ads they click on, and wherein the revenue generated for the advertiser comprises commission revenue for products sold on the e-commerce website.

4. The method of claim 3 wherein the e-commerce website comprises a product search engine, the method further comprising adding keywords to the keyword database based on keywords input by shoppers to the product search engine.

5. The method of claim 3 further comprising adding keywords to the keyword database based on keywords provided by the plurality of merchants.

6. The method of claim 1 wherein the revenue generated for the advertiser comprises advertising revenue.

7. The method of claim 1 wherein said providing a search engine comprises providing a plurality of search engines, and wherein said maintaining a keyword database, said collecting statistics, said maintaining a tracking database and said periodically revising are performed for each of the plurality of search engines.

8. The method of claim 1 further comprising modifying the keyword database by adding new keywords or deleting existing keywords.

9. The method of claim 1 wherein said periodically revising a bid amount comprises multiplying an average revenue, for revenues in the tracking database corresponding to the keyword over the given time period, by a factor between 0% and 100%.

10. The method of claim 1 wherein said periodically revising a bid amount comprises enforcing a prescribed lower limit on bid amounts, such that if a revised bid amount is less than the lower limit, then the lower limit becomes the revised bid amount.

11. The method of claim 1 wherein said periodically revising a bid amount comprises enforcing a prescribed lower limit on bid amounts, such that if a revised bid amount for a keyword is less than the lower limit, then the keyword is deactivated and not submitted to the search engine.

12. The method of claim 1 wherein said periodically revising a bid amount comprises enforcing a prescribed upper limit on bid amounts, such that if a revised bid amount is more than the upper limit, then the upper limit becomes the revised bid amount.

13. The method of claim 1 wherein said periodically revising a bid amount comprises limiting an increase of the bid amount to a prescribed change.

14. A system for keyword bidding within a search engine marketing system, comprising:
(a) an interface for a search engine that is used by shoppers to search for products and services, wherein the search engine receives at least one designated keyword as input and generates a ranked list of at least one ad related to the at least one designated keyword as output, wherein each ad is sponsored by an advertiser and has a bid amount associated therewith and includes a link to a landing page of an advertiser's website, wherein the list of sponsored ads generated by the search engine is ranked in order of the ads' respective bid amounts, and wherein higher ranked ads are more prominently displayed by the search engine and generally generate more revenue than lower ranked ads;
(b) a memory for storing (1) a keyword database used by the search engine, the keyword database comprising records, each record including (i) a designated keyword, (ii) an ad sponsored by the advertiser that is displayed by the search engine in response to a search using the designated keyword, and (iii) a bid amount that is paid by the advertiser to an operator of the search engine as a fee each time a shopper clicks on the advertiser's sponsored ad that is displayed by the search engine in response to the shopper's search using the designated keyword, and (2) a tracking database comprising records of Internet sessions for a plurality of shoppers, each record including (i) a designated keyword corresponding to a sponsored ad that a shopper clicked on, (ii) a time and date of the shopper's Internet session, and, (iii) revenue generated for the advertiser during the shopper's Internet session;
(c) a keyword tracker communicatively coupled with the tracking database, for collecting statistics for revenue generated during each Internet session on the advertiser's website that begins when a shopper visits the advertiser's landing page in response to the shopper clicking on an advertiser's sponsored ad; and
(d) a bid calculator communicatively coupled with the keyword database and the tracking database, for periodically revising by the advertiser a bid amount for a keyword in the keyword database, based on total revenue in the tracking database corresponding to the keyword over a given time period.

15. The system of claim 14 further comprising a keyword database manager for adding keywords to the keyword database based on keywords provided by the search engine.

16. The system of claim 14 wherein the advertiser's website is an e-commerce website for a plurality of merchants, at which shoppers purchase merchants' products related to sponsored ads they click on, and wherein the revenue generated for the advertiser comprises commission revenue for products sold on the e-commerce website.

17. The system of claim 16 wherein the e-commerce website comprises a product search engine, the system further comprising a keyword database manager for adding keywords to the keyword database based on keywords input by shoppers to the product search engine.

18. The system of claim 16 further comprising a keyword database manager for adding keywords to the keyword database based on keywords provided by the plurality of merchants.

19. The system of claim 14 wherein the revenue generated for the advertiser comprises advertising revenue.

20. The system of claim 14 further comprising a plurality of interfaces for a corresponding plurality of search engines, wherein said memory stores a corresponding plurality of keyword databases and tracking databases, wherein said statistics collector collects revenue statistics for each of the plurality of tracking databases, and wherein said bid calculator periodically revises bid amounts in each of the keyword databases.

21. The system of claim 14 further comprising a keyword database manager for modifying the keyword database by adding new keywords or deleting existing keywords.

22. The system of claim 14 wherein said bid calculator multiplies an average revenue, for revenues in the tracking database corresponding to the keyword over the given time period, by a factor between 0% and 100%.

23. The system of claim 14 wherein said bid calculator enforces a prescribed lower limit on bid amounts, such that if a revised bid amount for a keyword is less than the lower limit, then the keyword is deactivated and not submitted to the search engine.

24. The system of claim 14 wherein said bid calculator enforces a prescribed upper limit on bid amounts, such that if a revised bid amount is more than the upper limit, then the upper limit becomes the revised bid 1 amount.

25. The system of claim 14 wherein said bid calculator limits an increase of a bid amount to a prescribed change.
